(19) United States
(12) Patent Application Publication
(10) Pub. No.: US 2004/0167849 A1
(43) Pub. Date: Aug. 26, 2004

(54) Securities and transaction thereof

(76) Inventors: Jeffrey Yass, Haverford, PA (US); Thomas Kennedy, Broomall, PA (US); Michael Traynor, Downingtown, PA (US); Todd Silverberg, Cherry Hill, NJ (US)

Correspondence Address: Gregory J. Lavorgna, Drinker Biddle & Reath LLP, One Logan Square, 18th & Cherry Streets, Philadelphia, PA, 19103-6996, US

(21) Appl. No.: 10/783,655

(22) Filed: Feb. 20, 2004

Related U.S. Application Data
(60) Provisional application No. 60/449,529, filed on Feb. 21, 2003.

(51) Int. Cl. G06F 17/60

(52) U.S. Cl. 705/37; 705/36

(57) ABSTRACT

A security and its transaction are provided. In an illustrative implementation, a plurality of securities are provided that are aggregated/combined according to at least one instruction set to form a bundled instrument security. The illustrative implementation provides that, in practice, the exemplary bundled instrument security may be transacted at a bundled price. Furthermore, the implementation provides that the bundled price be derived from the price of the plurality of securities and a selected multiple value and/or security feature. The illustrative implementation further provides that options may be made available and/or transacted on the bundled instrument security.

### CLAIM FOR PRIORITY AND CROSS REFERENCE

This application claims priority to provisional application No. 60/449,529, filed Feb. 21, 2003, entitled “SECURITY SALES SYSTEM AND METHOD,” which is herein incorporated by reference in its entirety.

### FIELD OF THE INVENTION

The present invention is directed generally to securities and transaction thereof.

### BACKGROUND OF THE INVENTION

Business organizations, universally, turn to the equity and debt markets when seeking capital. Such capital may be used, among other things, to fund expansion and investment or to cure financial maladies. Generally, in exchange for investor dollars, investors receive a security representative of their equity and/or debt stake in the company seeking such capital. These securities are regulated by various regulatory agencies such as the Securities and Exchange Commission who set rules regarding, among other things, the creation and transaction of such securities. Given the unpredictability and volatility of securities markets, investors often seek to spread their risk among various securities investment types. For example, when the equity markets are under-performing, investors may turn to debt markets (e.g. bonds and debentures) to spread their investment risk and vice versa.

In the context of equity and debt markets, over the course of time, these markets may be subject to periods in which, as assessed in accordance to known factors, may experience periods or rising or upwardly stable pricing. Such time periods, often referred to as “bull” markets, are most prosperous for investors owning those securities that are upwardly moving.

However, historically, following a “bull” market or at other times there eventually occurs a market correction, during which stock prices, on average, fall. In the period following such a market correction, corporations, particularly those that have previously split their respective stocks, may be faced with large amounts of shares outstanding, coupled with a low stock price. These low-priced stocks may be generally disadvantaged in the marketplace since investors will stay away from trading low priced securities as they often pay more in relative commissions to brokers for executing a stock trade (i.e. buy or sell) than with higher priced securities (e.g. commission fees may be 5 times more costly for the same dollar investment in a $10 stock than in a $50 stock). Furthermore, option contracts on low priced stocks may be less useful in that fewer strike prices (i.e. less of a price range) are available, and at relatively wider intervals.

As a remedy for the disadvantages of lower stock prices, companies may elect to “reverse split” their stocks. Such reverse splits, in extreme cases, may be made in order to allow a company to retain its listing on an exchange, which exchange may have a minimum trading price as a requirement for the continued listing of that stock on the exchange. However, reverse splits are often viewed negatively as investors perceive such practice as an admission of poor financial performance by the stock issuer.

With currently traded instruments, investors are not afforded the ability to spread their risk in investing in a particular company using a singly transacted instrument. Stated differently, investors are currently relegated to perform more than one transaction to purchase or sell equity and debt from a particular issuer or to establish a risk profile (e.g. term, collateral, etc.) that is different from the risk profile of a singularly traded debt security. Such practice is inefficient and costly, as the investor is charged with tracking both the equity and various debt securities of the particular issuer and is forced to pay high commissions associated with trading multiple securities independently of each other.

Moreover, some currently traded securities (e.g. unbundled debt securities) offer little price transparency to their holders. Stated differently, investors may require more accurate and timely pricing information regarding a security at the time that they are making their investment decision.

Similarly, current practices are not advantageous to securities issuers as they are not afforded the ability to provide their investors with a single instrument that provides the benefits of a reverse stock split (e.g. increase in post-reverse-split stock price) without invoking many of the negative features associated with the traditional reverse-stock-split.

From the foregoing it is appreciated that there exists a need for system and methods providing a bundled instrument security that overcomes the shortcomings of the prior art.

### SUMMARY OF THE INVENTION

A security and its transaction are provided. In an illustrative implementation, a plurality of securities are provided that are aggregated/combined according to at least one instruction set to form a bundled instrument security. The illustrative implementation provides that, in practice, the exemplary bundled instrument security may be transacted at a bundled price. Furthermore, the implementation provides that the bundled price be derived from the price of the plurality of securities and a selected multiple value and/or security feature.

The illustrative implementation further provides that options may be made available and/or transacted on the bundled instrument security.

Other features are provided below and by the accompanying drawings.

### BRIEF DESCRIPTION OF THE DRAWINGS

For the purpose of illustrating the herein described system and methods, there is shown in the drawings an illustrative implementation; it being understood, however, that the herein described system and methods are not limited to the precise arrangements and instrumentalities shown. The drawings are not necessarily to scale, emphasis instead being placed on illustrating the principles of the herein described system and methods.

FIG. 1 is a block diagram of a securities system in accordance with the herein described system and methods;

FIG. 2 is a block diagram of the components of an exemplary security type in accordance with the herein described system and methods;

FIG. 3 is a block diagram of an exemplary security transaction environment;

FIG. 4 is a block diagram of an exemplary securities system and its components to transact an exemplary security type;

FIG. 5 is a flowchart diagram of the processing performed by an exemplary securities system when creating and transacting an exemplary security type; and

FIG. 6 is a chart diagram showing the relationship of various pricing charts for a new security type and its underlying components in accordance with the herein described system and methods.

### DETAILED DESCRIPTION OF THE ILLUSTRATIVE IMPLEMENTATIONS

Overview:

Income oriented mutual funds, whose portfolios generally consist of a diversified group of higher dividend yielding equities as well as higher quality corporate and treasury bonds are popular investment vehicles. The objective of these funds is normally to generate a relatively higher level of current income, with moderate growth in capital. One of the appeals of this vehicle is since the portfolio is balanced with both equities and fixed income securities, the relatively low correlations of the two asset classes generally helps to reduce the overall volatility of the fund.

As described herein, a system and methods that provide a bundled instrument security that contains both equity and debt of a single issuer may be useful to investors seeking more complete exposure to the capitalization of a single corporation. This bundled instrument security may provide a unique mechanism in which the price of combined corporate equity and credit may be accessible in one tradable security. Combining corporate equity and debt into a single tradable instrument may enable investors to gain exposure to the “enterprise” value of the company in one transaction. In an illustrative implementation, the security may comprise an open-ended trust. In the illustrative implementation, the security may be created by delivering a fixed number of equity shares and a fixed number of specified notes or bonds to a trustee, who then may issue a predetermined number of bundled instrument security shares. In operation, the exemplary trust may employ an arbitrage mechanism that, when invoked, may act to ensure that the price of the bundled instrument security is very close to the aggregate price of the underlying equity shares and note/bond price.

A single security that contains both the equity and debt of a single issuer may provide benefits to investors, since within exemplary bundled instrument security structure the investors in the bundled instrument security not only are beneficial owners of the underlying securities in the trust; but the bundled instrument security can be aggregated and disaggregated using the underlying securities comprising the trust. In the illustrative implementation, dividend income from the equity and interest income from the debt may be passed through to the bundled instrument security holder, resulting in a higher yielding security that is reflective of the distribution of the entire corporate free cash flow.

In the context of corporate credit, the bundled instrument security may provide additional trading positions to participating investors. Specifically, corporate credit is generally rated by the major agencies such as Standard & Poors and Moodys. These agencies assign ratings to particular corporate bond issues that vary depending on the agencies' independent assessment of the corporation's ability to meet the bond interest and principal obligations. Generally, the better the credit rating, the lower the rate of interest required on the bonds. Some factors that affect corporate creditworthiness can include strength of balance sheet, stability of cash flows, prospects for revenue/income growth, competitive position, industry health, etc.

When a company's corporate debt credit rating falls due to financial distress and greater likelihood of bankruptcy, the debt securities begin to trade and behave much more like its equity than interest rate sensitive debt. Investors buy and sell both the distressed debt and common equity as a way to take a view on the likelihood of further deterioration in corporate financial health. The exemplary bundled instrument security, thus, may serve as a unique tool for investors to make use of in these situations; rather than effecting separate transactions in the equity and debt securities.

Bundled Instrument Security:

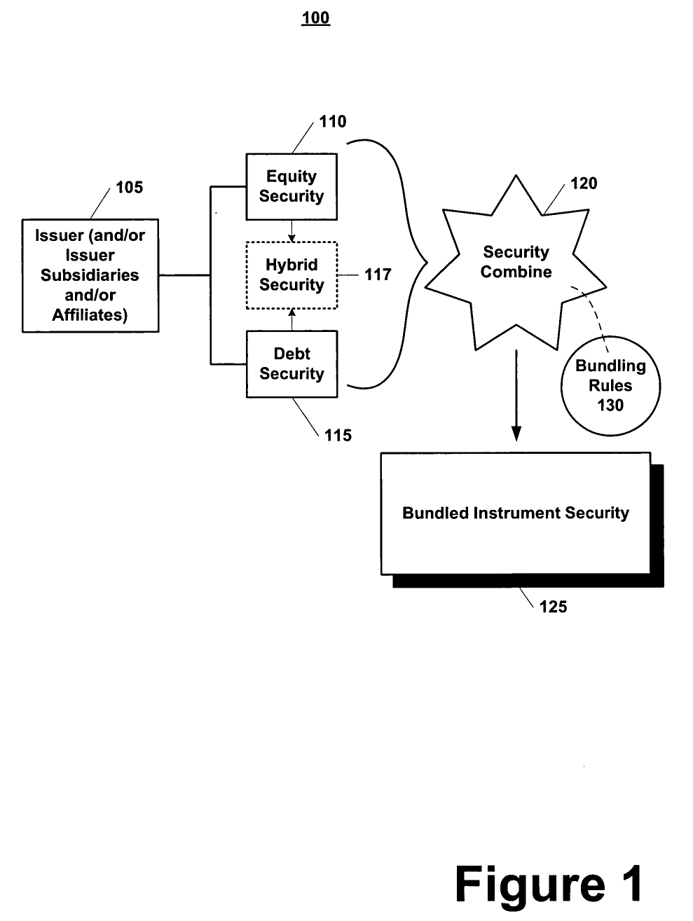

FIG. 1 is a block diagram showing the components and interaction of exemplary securities system 100. As is shown, exemplary securities system 100 comprises an issuer (and/or the issuer subsidiaries and/or affiliates) 100 that offers equity 110, and/or debt 115, and/or hybrid security 117. Additionally, as is shown, exemplary securities system 100 further comprises security combine 120 and bundled instrument security 125 operating according to bundling rules 130. In operation, equity 110 and/or debt 115 and/or hybrid 117 security of issuer (and/or the issuer subsidiaries and/or affiliates) 105 are combined/aggregated by security combine 120 operating according to bundling rules 130 to generate at least one bundled instrument security 125.

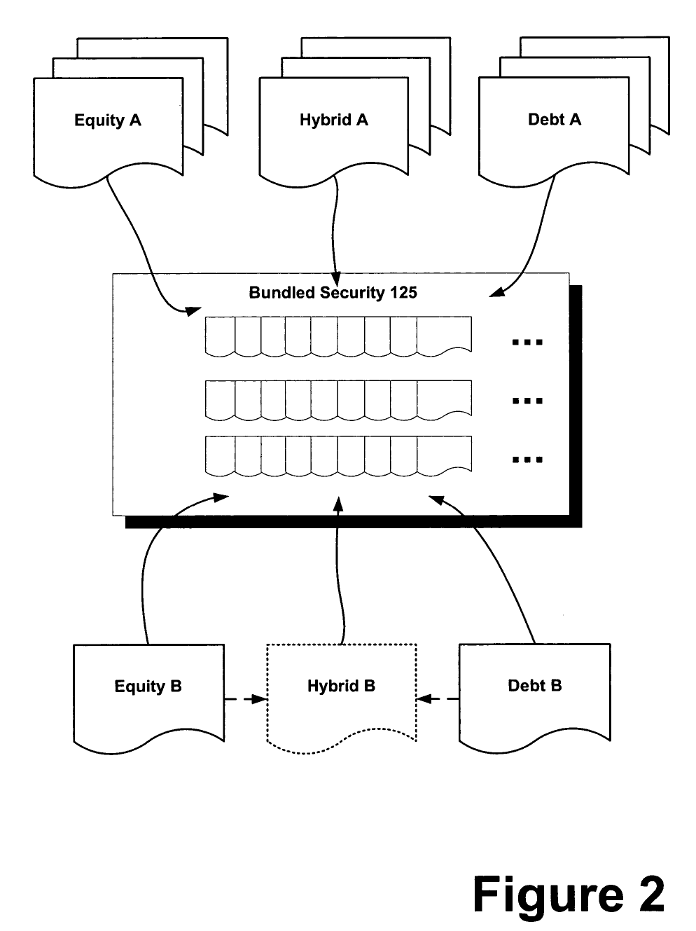

In an illustrative implementation, as is shown in FIG. 1 with reference to FIG. 2, bundled instrument security 125 may comprise therewithin a single or multiple types of a uniform equity 110 or debt 115 or hybrid 117 security (e.g. equity A and/or B, or debt A and/or B, or hybrid A and/or B) of issuer (and/or the issuer subsidiaries and/or affiliates) 105 according to a selected multiple based on bundling rules 130. Also, bundled instrument security 125 may comprise single or multiple types of disparate combinations of equity 110 and/or debt 115 and/or hybrid 117 securities (e.g. equity A and/or B, and/or debt A and/or B, and/or hybrid A and/or B) of issuer (and/or the issuer subsidiaries and/or affiliates) 105 according to selected multiples (e.g. 25 shares, 100, shares, 1000 shares, etc.) based on bundling rules 130. It is appreciated that although exemplary securities system 100 is described to comprise a bundled instrument security having exemplary values for the selected multiple and differing types, that such description is merely exemplary as any selected multiple may be employed by exemplary security system 100.

Furthermore, the specific share amounts for each bundled instrument security 125 may be determined prior to pricing of the bundled instrument security 125 according to bundling rules 130, such that the initial issue price of bundled instrument security 125 falls within a selected price range. It is appreciated that the pricing of bundled instrument security 125, according to bundling rules 130, may be derived from various values including, but not limited to, the number of shares of either of the equity 110 or debt 115 or hybrid 117 securities or a combination of these securities types, market value of either the equity 110 or debt 115 or hybrid 117 securities or a combination of these securities types, or the face amount of either the equity 110 or debt 115 or hybrid 117 securities or a combination of these securities types. The bundled instrument security 125 price may further be influenced and change in response to stock splits or reverse stock splits on the underlying equity 110 and/or debt 115 and/or hybrid 117 security, underlying securities redemptions, mandatory underlying securities conversion, corporate reorganization events. Also, the bundling rules may provide that upon the occurrence of one of these events (e.g. stock splits or reverse stock splits on the underlying equity 110 and/or debt 115 and/or hybrid 117 security, underlying securities redemptions, mandatory underlying securities conversion, corporate reorganization events), the share amounts of the underlying securities may change in an appropriate amount with no expected change to the bundled instrument security price.

Examples of securities that may be used to create bundled instrument security 125 may include, but are note limited to, equity 110, debt 115, and hybrid 117 securities. Examples of equity securities 110 may comprise any of common stock, preferred stock, convertible or exchangeable preferred and convertible preferred stock, warrants, options, certificates of deposit, American Depositary Receipts (ADR's), and interests in limited partnerships and limited liability companies. Examples of debt securities 115 may comprise any of unsecured notes and debentures (i.e., capital notes), secured notes (bonds and debentures), mortgage bonds, collateral trust bonds, convertible and exchangeable bonds, notes and debentures. Hybrid security 117, as is shown in FIG. 1 by the dotted lines, may comprise features of both debt 115 and equity 110 securities. A convertible preferred share and convertible note are examples of a hybrid security. It is appreciated that bundled instrument security 125 may also comprise encumbered or restricted securities such that bundled instrument security 125 may itself be subject to the same rules and regulations of as those applied to the underlying securities making up bundled instrument security 125.

In operation, securities may be selected for inclusion in bundled instrument 125 of exemplary securities system 100 based on a combination of factors, such as current share price, market capitalization, trading volume, listing venue, investor interest, and similar factors. For example, an illustrative implementation may target common stock of large cap NASDAQ stocks that have low stock prices and relatively high trading volume.

Impact of Bundled Instrument Securities:

Reverse Stock Splits:

In an illustrative implementation, bundled instrument security 125 may be employed to synthetically reverse split the stock within bundled instrument security 125. That is, bundled instrument security 125 may contain shares in predetermined multiples, or increments, that may result in effective pricing for investors. By way of example, given some stock of company ABC, such stock may be placed into a bundled instrument security that contains 10 shares of ABC stock, and which bundled instrument security is priced at 10 times a single share of underlying ABC stock.

Non-Dilution:

Additionally, bundled instrument security 125 may be structured as a depositary receipt or grantor trust, concepts that are known to those skilled in the art. In such context, an investor purchasing bundled instrument security 125 is not only the beneficial owner of bundled instrument security 125, but additionally is the beneficial owner of the underlying 10 shares that comprise bundled instrument security 125. As a result, in such structure, the investor in bundled instrument security 125 loses no voting rights and is not diluted.

Commissions:

In the context of commissions for the sale or disposition of bundled instrument security 125, the transaction of bundled instrument securities may result in commissions savings to potential investors. Specifically, commissions may be calculated based on a per share transaction price. In such case, the fewer shares traded, the lower the commission due. For example, at a commission of $0.005 per share, 1,000 shares of stock may cost $5 to trade, while 10,000 shares of stock may cost $50, although these portfolios may have the same value if the 1,000 shares of stock are valued at $60 per share, and the 10,000 shares are valued at $6 per share.

It is appreciated then, by way of this example, that the same trade expense of $5 (i.e. $0.005/share×1000 shares) is realized by trading a 1000 bundled instrument securities 125 having 10 shares of a $6 per share stock as the expense (i.e. $0.005/share×1000 shares) realized in trading the 1,000 shares stock valued at $60 per share. Had the $6 stock not been bundled prior to the transaction, the expense for trading such stock would have been $50 (i.e. $0.005/share×10,000 shares).

Options:

Moreover, options may be listed on bundled instrument security 125. It is appreciated that by employing options, a revitalization of trading occurs for the shares of companies that have volatile pricing and that are not cost effective to trade. Basis point spread, as appreciated by one of ordinary skill in the art, generally refers to the difference between the bid price and the ask price of a security or asset. The spread may be influenced by such factors including, but not limited to, the total number of outstanding shares available to trade, the demand in the stock, and the total trading activity of the stock. It is appreciated that the spread may be tighter (e.g. “closer”) in a higher priced bundle than in the single share. Conversion between the basis point spread and the dollar value of the spread may be calculated as:

DollarValueSpread=SharePrice×(BasisPointSpread÷10,000)

For example, if there is a 25 basis point spread on the $6 stock discussed hereinabove, there is a 1½ cent wide market as calculated using the equation immediately hereinabove. Often, a 1½ cent-wide market is treated as a 2 cent-wide market in practice, thereby operating as 33 basis point spread, rather than the actual 25 basis point spread. In the example hereinabove, on the $60 per share bundled instrument security, the dollar-value-spread is 15 cents. This dollar-value-spread of 15 cents, for the $60 per share is significantly higher than the $6 per share dollar value spread of 2 cents. It is appreciated that if the $6 per share is multiplied by a factor of 10 to equate the portfolio value with that of a bundled instrument security have a per share price of $60/bundled share, a 33% lower dollar-value-spread (i.e. 20 cents dollar-value-spread for the $6/share portfolio compared with 15 cents dollar value spread for the $60/bundled share portfolio) results for the bundled instrument security. Accordingly, it is appreciated that a tighter spread may be achieved with the transaction of a higher priced bundled instrument security than with the transaction of single security shares.

Arbitrage:

Furthermore, bundling may reduce transaction costs and may therefore allow more efficient arbitrage. Specifically, it is appreciated that arbitrage is the act of buying low and selling high. An arbitrageur purchases a set of financial assets at a low price and simultaneously sells that set at a high price. This simultaneity of the exchange is important in that arbitrageurs require no outlay of personal endowment. Rather, arbitrageurs set up a set of simultaneous contracts, such that the revenue generated from each selling contract pays off the costs of the immediately prior buying contract, thereby eliminating risk to the arbitrageur in that none of the arbitrageur's personal resources are ever needed to pay costs. This is referred to as pure arbitrage, the selling of the same product across different markets.

In addition, a like-instruments arbitrage may be employed, such as, for example, options relative to the underlying stock. An arbitrageur may establish a synthetic position in a stock utilizing options. This may allow the options on the stock and the stock itself to be traded in a familiar fashion. Investors may buy or sell the stock and buy or sell options in the stock in an arbitrage fashion. There may be costs associated with selling and buying in an arbitrage system, such as, for example, transactions costs including spread, exchange fees, and commissions. Arbitrage, generally, acts to keep markets efficient. In using bundled instrument securities 125, arbitrageurs may be positioned to effect trades of securities more efficiently (e.g. by transacting a bundled instrument security having therein aggregated a large block of securities, the arbitrageur can realize his/her end goal in fewer transactions—trades) and transact such trades at lower costs (e.g. commission costs, and spreads). Moreover, the increase in the liquidity of stocks through the use of bundled instrument security 125 may make investment in bundled instruments securities more attractive to investors who would not otherwise consider buying stock trading at low prices, regardless of the viability of the company issuing the low-priced stock.

Bundled Instrument Security Transaction:

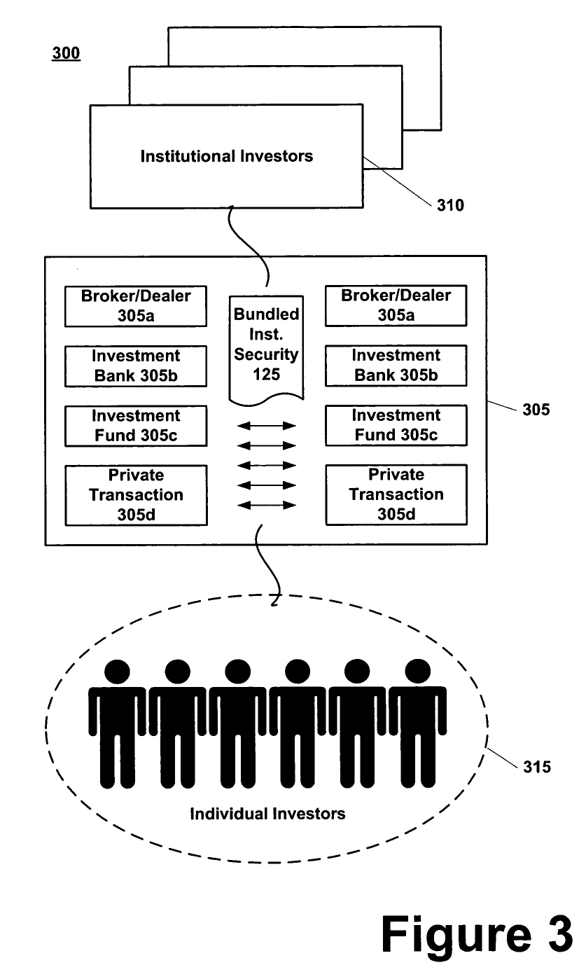

FIG. 3 shows exemplary securities transaction environment 300. As is shown, exemplary securities transaction environment 300 comprises securities marketplace 305, institutional investors 310 and individual investors 315. As is further shown, securities marketplace 305, further comprises broker/dealer 305a, investment bank 305b, investment fund 305c, private transactor 305d, and bundled instrument security 125. In operation, bundled instrument security 125 may be traded between the various participating parties (as indicated by the arrows), broker/dealer 305a, investment bank 305b, investment fund 305c, and private transactors 305d in exemplary securities marketplace 305. Furthermore, bundled instrument security 125 may traded by the participating parties broker/dealer 305a, investment bank 305b, investment fund 305c, and private transactor 305d on behalf of individual investors 315 and/or institutional investors 310 (as indicated by the curved lines). Private transactors may comprise individuals and/or business entities who transact bundled instrument security 125 as part of a private transaction to subject to compliance with governing rules and regulations surrounding the disposition or sale of encumbered or restricted securities.

In an illustrative implementation, exemplary securities marketplace 305 may comprise any of over the counter securities boards, electronic communications networks (ECNs), electronic securities marketplaces, such as NASDAQ®, or physical market places such as the New York Stock Exchange (NYSE®) and the American Stock Exchange (AMEX®). Furthermore, bundled instrument security 125 may be traded using electronic transaction systems (not shown) employed by one or more of the various participating parties comprising any of broker/dealer 305a, investment bank 305b, investment fund 305c, private transactor 305d, institutional investors 310, and individual investors 315.

Exemplary Bundled Instrument Securities System:

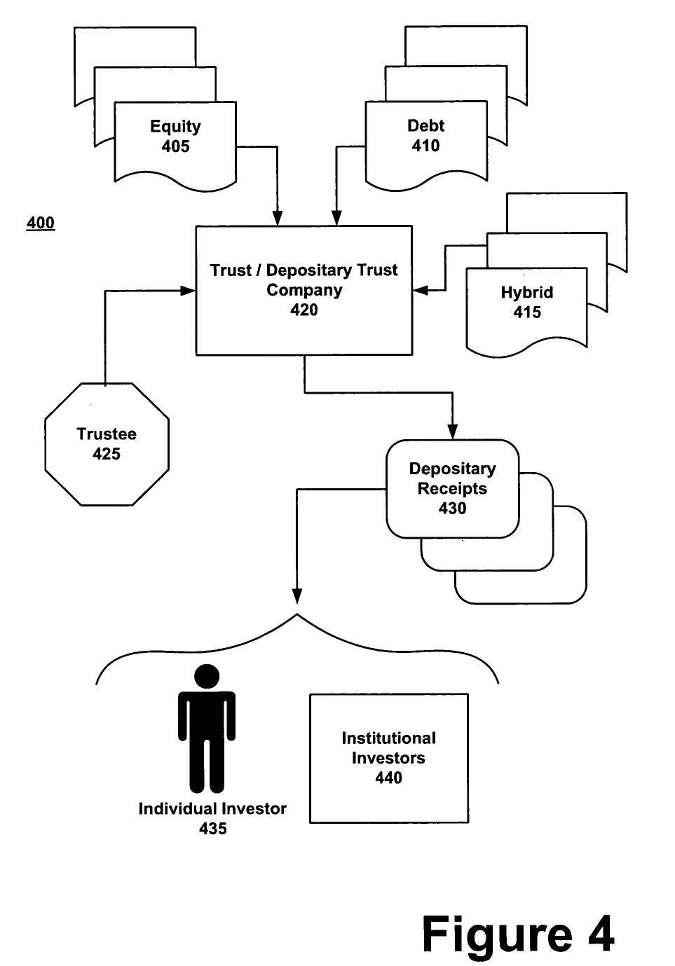

FIG. 4 shows exemplary bundled instrument securities system 400. As is shown, exemplary bundled instrument securities system 400 comprises equity 405, debt 410, and hybrid 415 securities, trust/depositary trust company 420, trustee 425, depositary receipts 430, individual investor 435, and institutional investors 440. In operation, under the direction of trustee 425, exemplary bundled instrument securities system 400 employs trust 420 to aggregate/combine equity 405, debt 410, and/or hybrid securities 415 to generate a bundled instrument security (not shown). The trustee then issues from the trust depositary receipts 430 representative of the generated bundled instruments security (not shown). The depositary receipts 430 are then purchased by individual investor 435 and/or institutional investors 440.

As is shown in FIG. 4, trust 420 issues depositary receipts 430 representing undivided beneficial ownership in the predetermined number of the underlying securities (e.g. equity 405 and/or debt 410 and/or hybrid 415 securities) of a particular bundled instrument security (not shown). In an illustrative implementation, a bank may be the trustee of the trust, and may thereby create additional universal economic benefit by receiving compensation resulting from the depositary trust agreement. In the implementation provided, the trustee may perform administrative and/or ministerial acts surrounding the trust and the depositary receipts. Furthermore, in the illustrative implementation, the property of the trust may consist of the underlying securities, and all monies or other property, if any, received by the trustee. Furthermore, in practice, trust 420, under the direction of trustee 425, may issue additional bundled instrument securities on a continuous basis.

In an illustrative implementation, holders of a bundled instrument security (not shown) as represented by depositary receipts 430 issued by trust 420, as beneficial owners of the securities underlying the bundled instrument security (not shown), may have the right to receive all shareholder disclosure materials, including annual and quarterly reports, distributed by an issuer of the underlying securities; receive all proxy materials distributed by an issuer of the underlying securities; instruct the trustee to vote the underlying securities; attend shareholder meetings; receive interest, dividends, and other distributions on the underlying securities, if any are declared and paid to the trustee by an issuer of the underlying securities, net of any applicable taxes or fees; and redeem the bundled instrument security to receive the underlying securities, as discussed further hereinbelow.

Furthermore, a receipt holder that owns the bundled instrument security (not shown) issued by trust 420 may be treated, for U.S. federal income tax purposes, as directly owning a proportionate share of the underlying security (e.g. equity 405, debt 410, and/or hybrid 415 security) represented by the bundled instrument security (not shown). Consequently, if there is a taxable cash distribution on an underlying security (e.g. equity 405, debt 410, and/or hybrid 415 security), a receipt holder will recognize income with respect to the distribution at the time the distribution is received by the trustee, not at the time that the holder receives the cash distribution from the trustee. Thereby, the trust may provide flow-through of tax consequences, and, in such context, may be treated as a grantor trust, wherein the grantor retains interest and control in the trust and therefore is taxed on any income from the trust, or as a custodial arrangement, for U.S. federal income tax purposes.

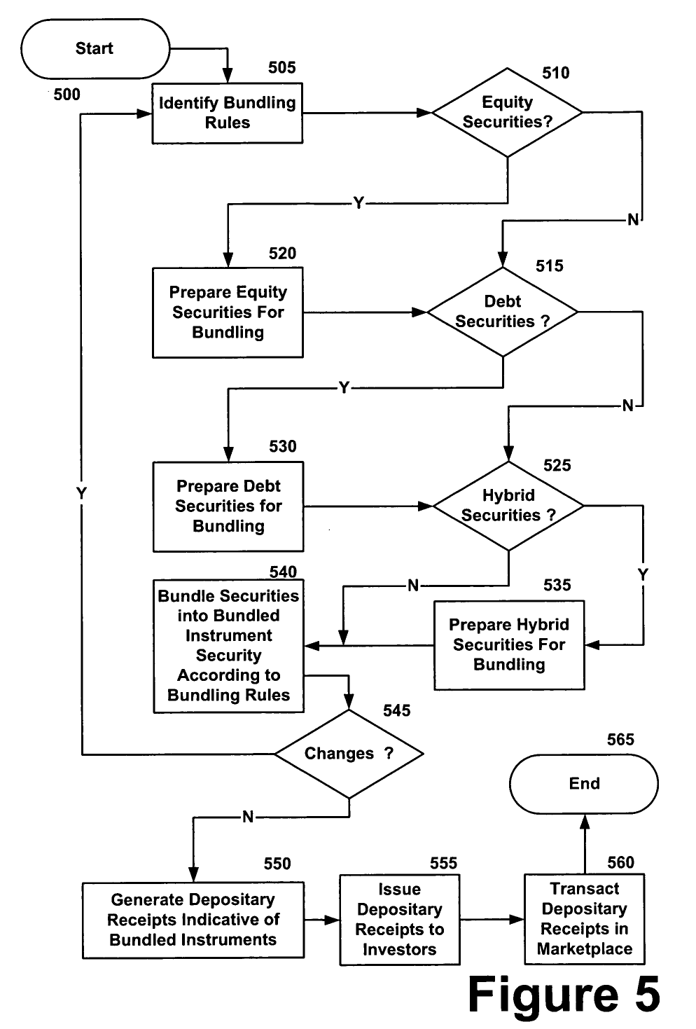

FIG. 5 is a flow diagram of the processing performed by exemplary bundling instrument securities system 400. As is shown, processing begins at block 500 and proceeds to block 505 where bundling rules are identified. The bundling rules may comprise, among others, various instructions of how to price the generated bundled instrument security, which securities to bundle together, how many securities to bundle, criteria for bundling including but not limited to current share price, market capitalization, trading volume, listing venue, investor interest, and the addition or substitution of securities in a bundled instrument security upon the occurrence of certain events affecting the issuer. From block 505 a check is performed at block 510 to determine if there are equity securities to include in the bundled instrument security. If at block 510 it is determined that there are not equity securities to bundle, processing proceeds to block 515 where a check is performed to determine if there are debt securities to bundle in the bundled instrument security. If at block 515 it is determined that there are no debt securities to bundle in the bundled instrument security, processing proceeds to block 525 where a check is performed to determine if there are any hybrid securities to include in the bundled instrument security. If at block 525 it is determined that there are no hybrid securities to bundle, processing proceeds to block 540 where the securities are bundled into a bundled instrument security according to the identified bundling rules.

From block 540, processing proceeds to block 545 where a check is performed to determine if there are any changes needed to the generated bundled instrument security. If the check at block 545 indicates that there are changes to be made to the generated bundling instrument security, processing reverts back to block 505 and continues from there. However, if at block 545 it is determined that there are no changes required to the generated bundled instrument security, processing proceeds to block 550 where depositary receipts indicative of the securities of the bundled instrument security are generated. From there, processing proceeds to block 555 where the depositary receipts are issued to investors. The depositary receipts are then transacted in various marketplaces at block 560. From there processing terminates at block 565.

If, however, at block 510 it is determined that there are equity securities to include in the bundled instrument security, processing proceeds to block 520 where the equity securities are prepared for bundling. From there, processing proceeds to block 515 and continues from there. Also, if at block 515 it is determined that there are debt securities to include in the bundled instrument security, processing proceeds to block 530 where the debt securities are prepared for bundling. From block 530, processing proceeds to block 525 and continues from there. Lastly, if at block 525, it is determined that there are hybrid securities to include in the bundled instrument security, processing proceeds to block 535 where the hybrid securities are prepared for bundling. From block 535, processing proceeds to block 540 and continues from there.

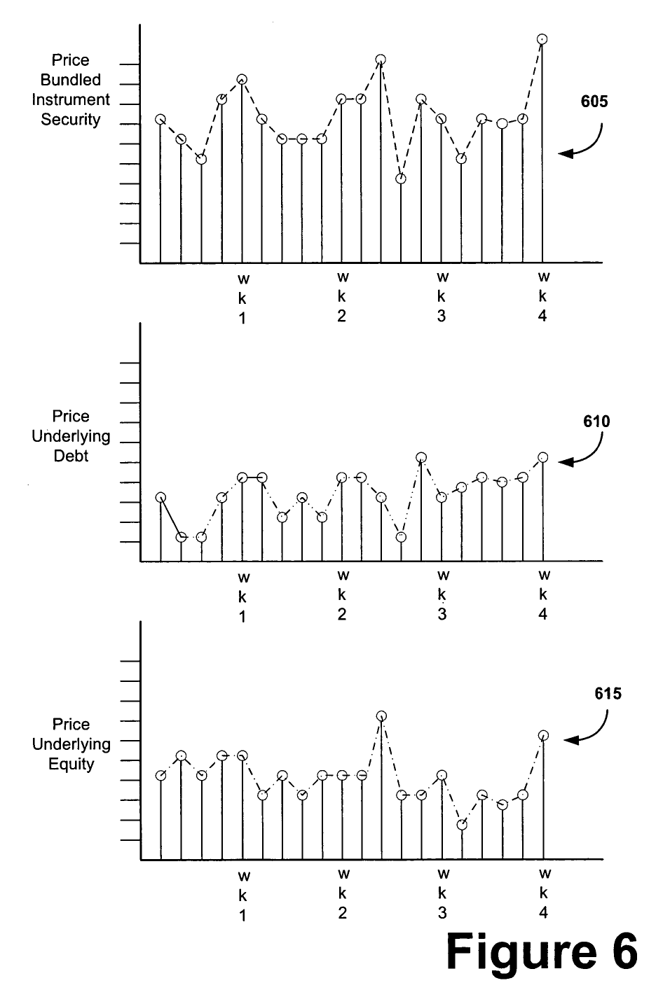

FIG. 6 shows the pricing relationship between a bundled instrument security and its underlying security components as illustrated by pricing charts 605, 610, and 615, respectively. It is appreciated that the exemplary bundled instrument security provided in FIG. 6 is composed of a debt security and an equity security having their own trading prices. As is shown in FIG. 6, a first chart 605 is provided which shows the price of a bundled instrument security over a business trading month (e.g. 5 days per week for four weeks). As is shown, the price of the bundled instrument security fluctuates between 4 and 11 bars during weeks 1-4. Chart 610 describes the price during a business trading month of the underlying debt security used to create the exemplary bundled instrument security. As is shown, the price of the underlying debt security ranges between 1 and 5 bars during weeks 1-4. Lastly, chart 615 describes the prices during a business trading month of the underlying equity security used to create the exemplary bundled instrument security. As is shown, the prices of the underlying equity security ranges between 1.5 and 6 bars during weeks 1-4.

It is appreciated that the charts provided in FIG. 6 are not be drawn to scale but are provided to describe the notion that the bundled instrument security price is approximately the aggregate of the prices of its underlying securities. Additionally, it is further appreciated that the charts of FIG. 6 indicate a direct relationship between the price fluctuation in the bundled instrument security and its underlying security components.

It is further appreciated that acts described in FIG. 5 may be performed, for example, by computer software code associated with a computer processor. For example, the computer software code may balance the bundling criteria in order to select securities for bundling. Further, selling and/or redeeming bundled instrument securities may be performed by the computer software code, and this software code may additionally allow for access for review or selling or redeeming activities, such as by a network, to the bundled instrument securities by the investors in the bundled instrument securities.

Additionally, it is further appreciated that many modifications and variations of the herein described system and methods may be implemented. The foregoing description and the following claims are intended to cover all such modifications and variations.

What is claimed is:

1. A system for transacting securities, comprising:
a plurality of securities; and
a securities combine aggregating the securities in at least one bundled instrument security for transaction.

2. The system as recited in claim 1, wherein the securities comprise any of debt, equity, and hybrid securities.

3. The system as recited in claim 1, further comprising bundling rules that instruct the security combine to bundle the securities when creating the bundled instrument security.

4. The system as recited in claim 2, wherein the security combine is a trust operated under the guidance of a trustee.

5. The system as recited in claim 4, wherein the trustee is a bank.

6. The system as recited in claim 4, wherein the bundled instrument security is represented by depositary receipts issued by the trust and administered by the trustee.

7. The system as recited in claim 6, wherein the depositary receipts are traded on public securities marketplaces, ECNS, and exchanges.

8. The system as recited in claim 7, wherein the depositary receipts are traded as part of a private securities transaction.

9. The system as recited in claim 1, wherein the securities are of the same type being issued by a single issuer.

10. The system as recited in claim 1, wherein the securities are of disparate securities types comprising any of equity, debt, and hybrid securities.

11. The system as recited in claim 1, wherein the system operates in a computing environment such that the security combine comprises a computing application.

12. The system as recited in claim 1, wherein the bundled instrument security is generated from a selected multiple of the plurality of the securities.

13. The system as recited in claim 12, wherein the selected multiple has a value in a selected range in compliance with securities regulations.

14. The system as recited in claim 12, wherein the selected multiple changes responsive to one or more changes affecting the plurality of securities comprising any of a security split, a reverse security split, and a reorganization event.

15. The system as recited in claim 12, wherein the selected multiple is based on at least one factor comprising any of current share price, market capitalization, trading volume, listing venue, and investor interest.

16. The system as recited in claim 1, wherein the bundled instrument security is sold to, or redeemed by, investors in accordance with at least one option position.

17. The system as recited in claim 1, wherein a dollar value spread is tighter in the bundled instrument security than in the ones of the plurality of securities.

18. The system as recited in claim 1, wherein receipt from an investor of the bundled instrument security comprises a redemption of the bundled instrument security, and wherein the redemption of the bundled instrument security comprises an expulsion of the securities of the plurality of securities comprising the bundled instrument security from the bundled instrument security.

19. The system of claim 1, wherein said bundled instrument security comprises a cash distribution issued on the units of said plurality, wherein the cash distribution is indirectly paid to at least one of the investors.

20. The system as recited in claim 1, further comprising a first fee that is charged when creating the bundled instrument security.

21. The system of claim 1, further comprising a second fee that is charged for the redemption of the bundled instrument security.

22. A method of transacting a security comprising:
providing a plurality of securities;
providing at least one bundling rule for application to the plurality of securities; and
aggregating the plurality of securities according to the at least one bundled rule to generate a bundled instrument security.

23. The method as recited in claim 22 further comprising transacting the bundled instrument security in private or public physical and electronic securities marketplaces.

24. The method as recited in claim 23 further comprising applying bundling criteria comprising any of a security price, market capitalization, trading volume, listing venue of the plurality of the securities and investor interest in the plurality of securities.

25. The method as recited in claim 22 further comprising bundling uniform typed units of the plurality of securities to generate the bundled instrument security.

26. The method as recited in claim 22 further comprising bundling disparate typed units of the plurality of securities to generate the bundled instrument security.

27. The method as recited in claim 22 further comprising selling the bundled instrument security to at least one investor at a price based on a multiple of at least one of the plurality of the securities.

28. The method as recited in claim 27 further comprising selecting the multiple from a range complying with securities rules and regulations.

29. The method as recited in claim 27 further comprising changing the multiple responsive to one or more events surrounding the plurality of securities comprising any of: a security split, a reverse-security-split, a reorganization event, mandatory redemption, and mandatory conversion.

30. The method as recited in claim 22 further comprising redeeming the bundled instrument security from at least one investor for an expulsion of at least one of the plurality of securities from the bundled instrument security.

31. The method as recited in claim 30 further comprising purchasing the expelled at least one security of the plurality of securities.

32. The method as recited in claim 30 further comprising providing an option position on the at least one of the plurality of securities.

33. The method as recited in claim 22, wherein said aggregating comprises aggregating a selected number of the plurality of securities to generate the bundled instrument security.

34. The method as recited in claim 22, further comprising issuing at least one tradable receipt for the bundled instrument security.

35. The method as recited in claim 34, further comprising listing the tradable receipts on a an exchange comprising any of a national securities exchange, ECNs, and NASDAQ.

36. The method as recited in claim 22, further comprising charging a fee when transacting the bundled instrument security.

37. A system providing a security for transaction, comprising:
a first means for applying bundling criteria comprising any of security price, market capitalization, trading volume, a listing venue of at least one of a plurality of securities, and investor interest in at least one of a plurality of securities;
second means for bundling a plurality of single issuer, uniform typed units of the at least one security into a bundled instrument security in accordance with the bundling criteria;
third means for selling the bundled instrument security to at least one investor at a price that is a predetermined multiple of at least one unit of the at least one security; and
fourth means for redeeming the bundled instrument security from at least one investor for an expulsion of the at least one security from the bundled instrument security.

38. A security transaction system, comprising:
a plurality of securities; and
at least one bundled instrument security that comprises a selected multiple of at least one of the plurality of securities;
wherein the at least one bundled instrument security is sold to, and redeemed by, investors at a bundle price selected in accordance with a price of at least one of the plurality of securities, and with the predetermined multiple.

39. The security transaction system of claim 38, wherein the securities comprise any of equity, debt, and hybrid securities.

40. The security transaction system of claim 39, wherein the equity securities are selected from the group consisting of common stock, preferred stock, convertible or exchangeable preferred and preference stock, warrants, options, American Depositary Receipts, and interests in limited partnerships and limited liability companies.

41. The security transaction system of claim 39, wherein the debt securities comprise any of unsecured notes and debentures, secured notes, mortgage bonds, collateral trust bonds, convertible and exchangeable bonds, notes and debentures.

42. The security transaction system of claim 39, wherein the hybrid securities comprise convertible notes.
